(19) United States
(12) Patent Application Publication
(10) Pub. No.: US 2026/0326666 A1
(43) Pub. Date: Oct. 22, 2026

(54) VEHICULAR INTERIOR REARVIEW MIRROR ASSEMBLY WITH ACTUATOR

(71) Applicant: Magna Mirrors of America, Inc., Holland, MI (US)

(72) Inventor: Anthony J. LaCross, Hastings, MI (US)

(21) Appl. No.: 19/652,272

(22) Filed: Apr. 20, 2026

Related U.S. Application Data
(60) Provisional application No. 63/792,414, filed on Apr. 22, 2025.

(51) Int. Cl. B60R 1/08; B60R 1/04; B60R 1/12; B60R 1/26; G02B 7/18

(52) U.S. Cl. CPC B60R 1/087; B60R 1/04; B60R 1/12; B60R 1/26; G02B 7/1805; B60R 2001/1253

(57) ABSTRACT

A vehicular interior rearview mirror assembly includes a mirror head that is adjustable to set a rearward view for a driver. An electrically-operable actuator is operable to tilt the mirror head relative to a mounting base. The actuator includes a socket element that receives a ball member, a cam gear having an arcuate track, a motor that drives the cam gear, and a pivot link pivotally attached at the socket element and including a pin. When the actuator is operated, the pin of the pivot link rides along the arcuate track to tilt the mirror head between first and second orientations.

### CROSS REFERENCE TO RELATED APPLICATION

The present application claims the filing benefits of U.S. provisional application Ser. No. 63/792,414, filed Apr. 22, 2025, which is hereby incorporated herein by reference in its entirety.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a single ball pivot or joint mounting configuration or double ball pivot or joint mounting configuration where the mirror casing and reflective element are adjusted relative to the interior portion of a vehicle by pivotal movement about the single or double ball pivot configuration. The mirror casing and reflective element are pivotable about either or both of the ball pivot joints by a user that is adjusting a rearward field of view of the reflective element. It is also generally known to provide an interior mirror assembly with a prismatic reflective element that may be manually toggled between daytime and nighttime reflectivity positions, such as described in U.S. Pat. No. 6,318,870, which is hereby incorporated herein by reference in its entirety.

### SUMMARY OF THE INVENTION

A vehicular interior rearview mirror assembly includes a mirror head adjustable about a mounting base, where the mounting base is configured to mount the vehicular interior rearview mirror assembly to an interior portion of an interior cabin of a vehicle. The mirror head accommodates a mirror reflective element. With the vehicular interior rearview mirror assembly mounted at the interior portion of the interior cabin of the vehicle, the mirror head is adjustable by a driver of the vehicle to set a rearward view for the driver. With the vehicular interior rearview mirror assembly mounted at the interior portion of the interior cabin of the vehicle, an actuator is operable to adjust the mirror head between at least (i) a first orientation where the mirror head is disposed at a first position relative to the mounting base and (ii) a second orientation where the mirror head is tilted from the first position to a second position relative to the mounting base different from the first position. With the vehicular interior rearview mirror assembly mounted at the interior portion of the interior cabin of the vehicle, the actuator is fixed relative to the mounting base. The actuator includes (i) a socket element that adjustably receives a ball member attached to the mirror head, (ii) a cam gear having an arcuate track, (iii) an electrically operable motor that drives the cam gear and (iv) a pivot link pivotally attached at a first end to the socket element and pivotally attached at an opposing second end to the cam gear. With the vehicular interior rearview mirror assembly mounted at the interior portion of the interior cabin of the vehicle, and when the actuator is operated, the socket element pivots relative to the mounting base to adjust the mirror head between the first orientation and the second orientation. When the actuator is operated, a pin at the second end of the pivot link rides along the arcuate track of the cam gear to impart movement of the first end of the pivot link and the socket element.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicular interior rearview mirror assembly;

FIG. 2 is a schematic view of a vehicular interior rearview mirror assembly having a camera disposed at a lower portion of the mirror head and a toggle element for adjusting the mirror head relative to the mounting structure;

FIGS. 3-7 are views of an actuator having a socket element configured to receive a ball member of the mirror head and that is operable to adjust the socket relative to the actuator to adjust orientation of the mirror head;

FIGS. 8-12 are views of a gear train of the actuator; and

FIG. 13 is an exploded view of the actuator.

### DESCRIPTION OF THE PREFERRED EMBODIMENTS

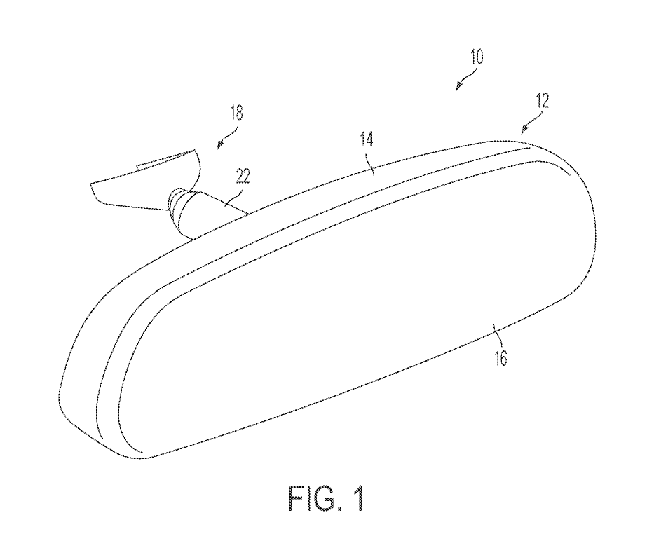

Referring now to the drawings and the illustrative embodiments depicted therein, a vehicular interior rearview mirror assembly 10 includes a mirror head 12 that includes a casing 14 and a reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror reflective element 16 may comprise a prismatic mirror reflective element that comprises a wedge-shaped glass substrate that can be flipped between a daytime orientation and a nighttime or anti-glare orientation.

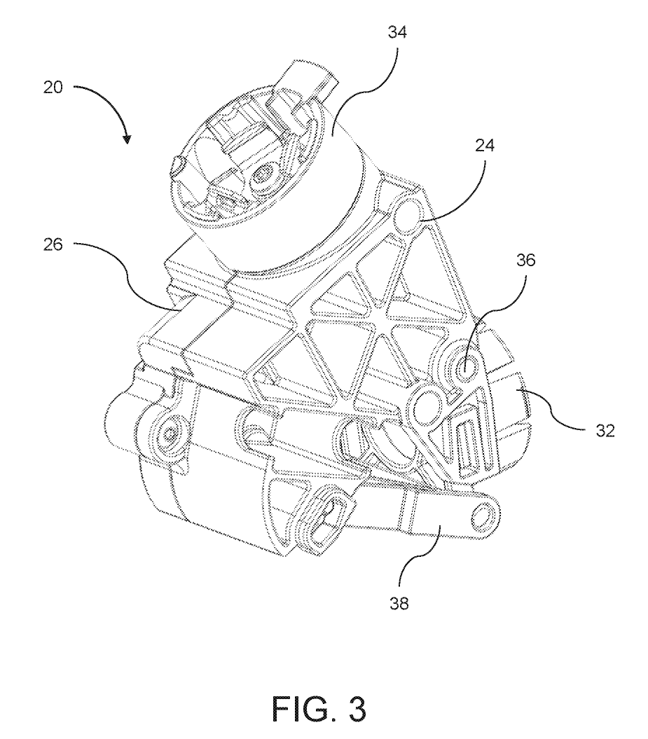

That is, the mirror reflective element 16 may comprise a prismatic glass substrate having a front or first surface (the surface that generally faces the driver of the vehicle when the mirror assembly is normally mounted at the vehicle) and a rear or second surface opposite the first surface, where the first surface and the second surface are at an oblique angle relative to one another. A mirror reflector coating may be disposed at the second surface for providing reflections for viewing by the driver of the vehicle. The mirror head 12 is adjustable at least between the daytime mirror mode orientation, where the mirror head is configured to provide a brighter reflection at the mirror reflective element 16 for viewing by the driver (e.g., the reflection is from the second surface) and the nighttime mirror mode orientation, where the mirror head is tilted upward from the daytime mirror mode orientation (e.g., five degrees) to provide a dimmer reflection at the mirror reflective element 16 for viewing by the driver (e.g., the reflection is from the first surface). As discussed further below, the mirror assembly 10 includes a toggle mechanism or actuator 20 (FIG. 3) that is electrically operable to adjust the mirror head 12 between at least the daytime orientation and the nighttime orientation, such as responsive to a user input or automatically based on detection of glare light at the mirror reflective element.

Optionally, the mirror assembly 10 may include a video display screen disposed behind the mirror reflective element 16. When the video display screen is not being operated, the driver may view the rearward view via reflections at the mirror reflective element 16. When the video display screen is being operated, the video display screen displays video images that are viewable through the mirror reflective element 16, such as to display video images representative of the rearward view provided by the mirror reflective element. The actuator 20 may be operable to tilt the mirror head between a mirror mode orientation where the driver views reflections at the mirror reflective element 16 and a video display mode where the mirror head is tilted upward (e.g., five degrees) and the video display screen is operated to display images viewable through the mirror reflective element 16. This may direct reflections from the mirror reflective element 16 away from the view of the driver to improve visibility of the video images. In such a video mirror with full mirror display, the mirror head may accommodate a prismatic mirror reflective element or a mirror reflective element with a single planar glass substrate with the first surface parallel to the second or rear surface or an electro-optic (e.g., electrochromic or liquid crystal) mirror reflective element.

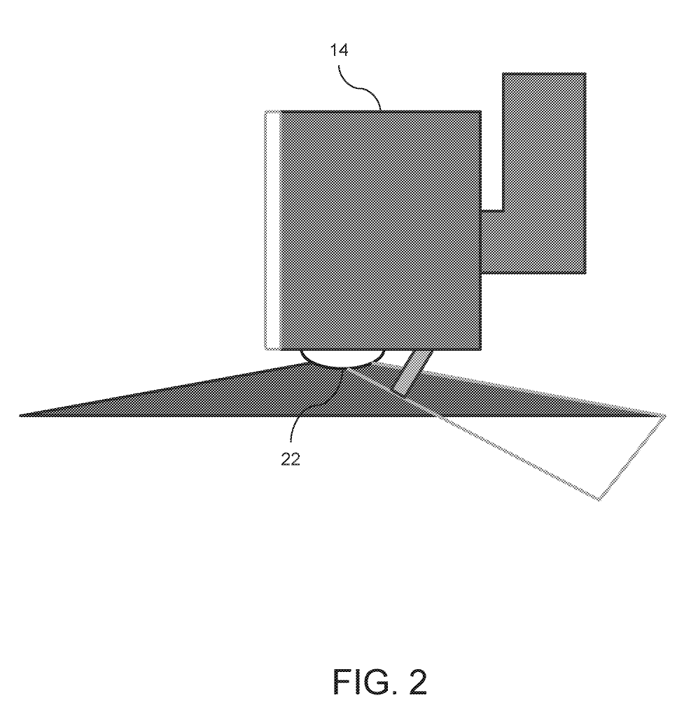

Further, the mirror assembly 10 may include a camera 22 disposed at a lower portion of the mirror head 12 and viewing at least a portion of the interior cabin of the vehicle (FIG. 2). The camera 22 may view at least partially downward and away from the mirror head 12 to view a portion of the interior cabin in close proximity to the mirror head, such as a driver region or front passenger region of the interior cabin. The camera 22 may comprise a driver monitoring camera for a driver monitoring system (DMS) and/or an occupant monitoring camera for an occupant monitoring system (OMS) of the vehicle. For example, the mirror assembly may utilize characteristics of the mirror assemblies and DMS/OMS described in U.S. Patent Application Ser. No. 19/459,447, filed Jan. 26, 2026 (Attorney Docket MAGO4 P5522) and/or International Publication Nos. WO 2026/019985, which are hereby incorporated herein by reference in their entireties. As shown in FIG. 2, a toggle for adjusting the mirror head between the daytime mirror mode and the nighttime mirror mode and/or for adjusting the mirror head between the mirror mode and the video display mode may obstruct at least a portion of the field of view of the camera 22.

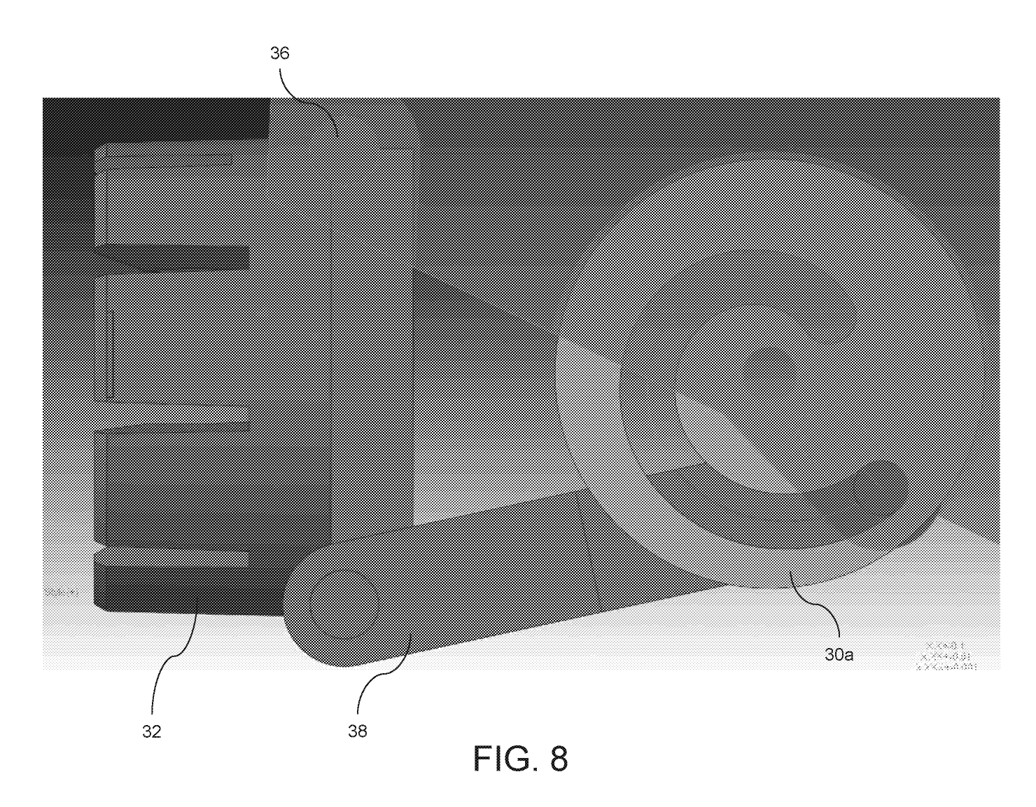

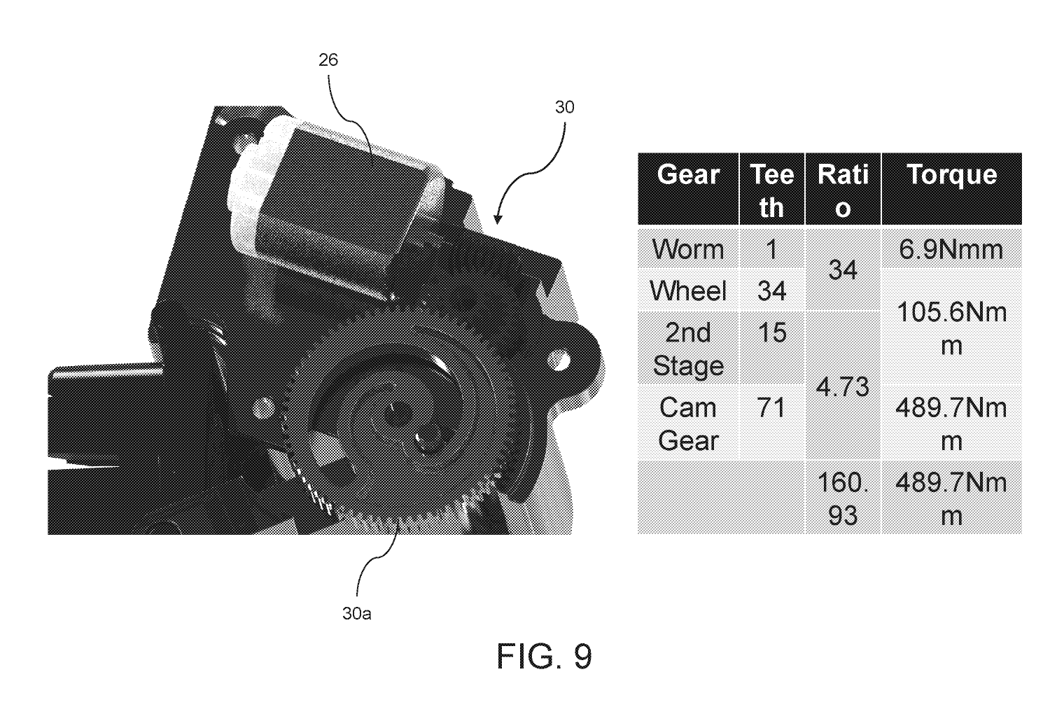

Referring to FIGS. 3-13, the actuator 20 is electrically operable to adjust the mirror head relative to the mounting structure 18 between positions (e.g., between the daytime mirror mode and the nighttime mirror mode), such as responsive to a user input (e.g., a button on the mirror head or at a steering wheel or infotainment system of the vehicle), responsive to a sensor input (e.g., detection of glare light at the mirror reflective element or responsive to a determined level of ambient light), and the like. This eliminates the need for a toggle or flip mechanism at the mirror head and allows the mirror head to be utilized with one or more DMS and/or OMS cameras at the bottom portion of the mirror head. Further, the actuator 20 may be integrally formed with or include at least a portion of the mounting structure 18 to provide for easy mounting in vehicles (e.g., at the inside surface of the windshield) and/or use with existing mounting structure at the interior portion of the cabin.

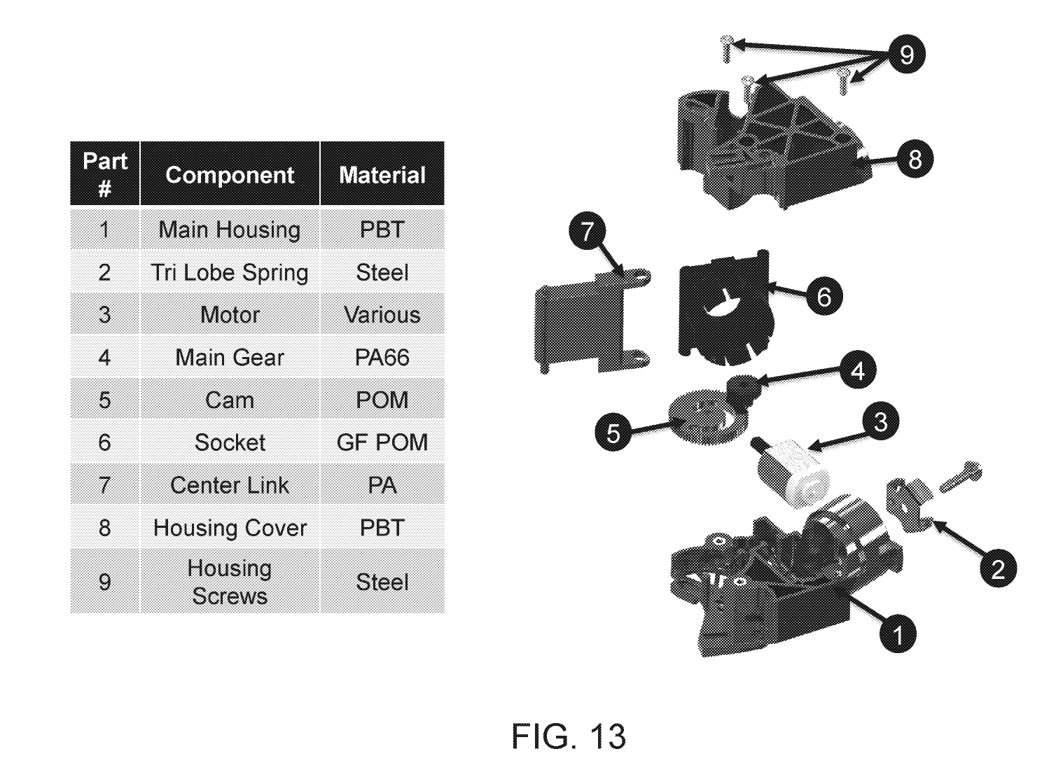

In the illustrated example, the actuator 20 includes a housing having a first portion 24 and a second portion 26 that join together and accommodate an electrically operable motor 28 and gear train 30 within the housing. When the motor 28 is electrically operated and drives the gear train 30, a socket element 32 pivots relative to the housing of the actuator 20. The housing may be attached at the interior portion of the vehicle, such as via a mounting stay or mounting button 34 extending from the housing that attaches (e.g., adhesively attaches) at the interior portion of the vehicle (FIG. 13), and the socket element 32 may receive a ball member extending from the mirror head 12. Thus, the mirror head 12 is attached at the actuator 20 via a ball and socket connection and the actuator 20 operates to pivot the socket element 32 relative to the actuator housing to move the mirror head between the daytime position and the nighttime position.

The socket element 32 is pivotally disposed at the actuator housing, such as via a pivot pin or pivot axis 36 at an upper portion of the socket element 32. Further, a pivot link 38 is pivotally attached at a lower portion of the socket element 32 and is adjustable during operation of the motor 28 to impart movement of the socket element 32 about the pivot axis 36. For example, a first end of the pivot link 38 is pivotally attached to the lower portion of the socket element 32 and an opposite second end of the pivot link 38 is pivotally attached to a first gear or cam gear 30a of the gear train 30.

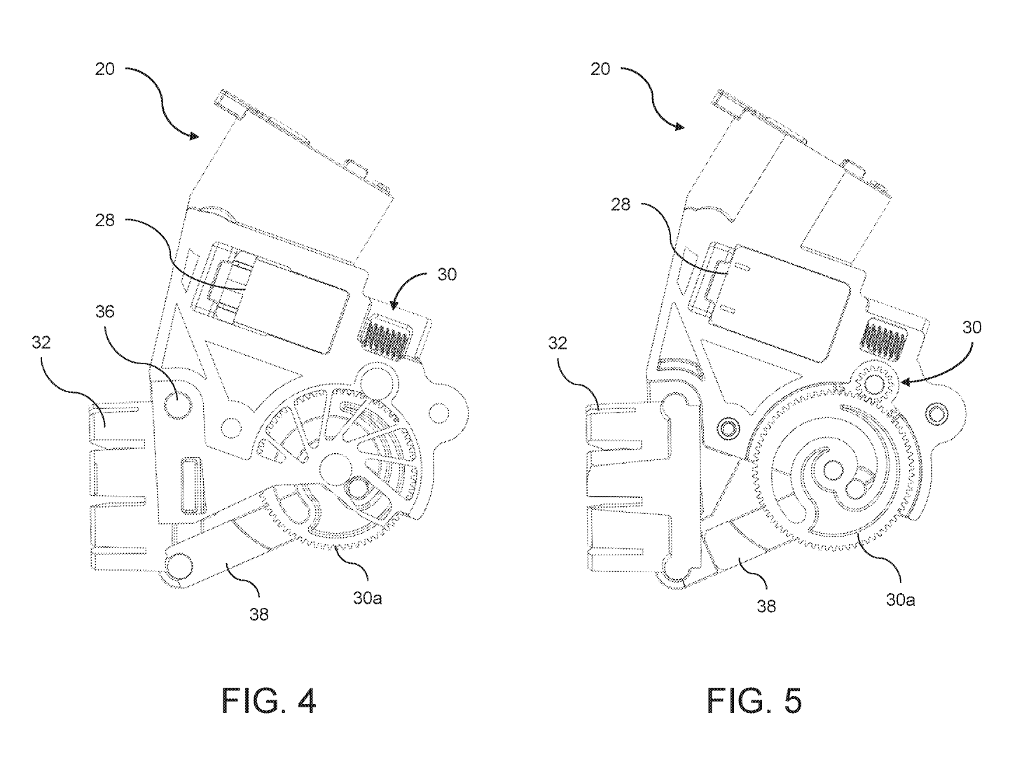

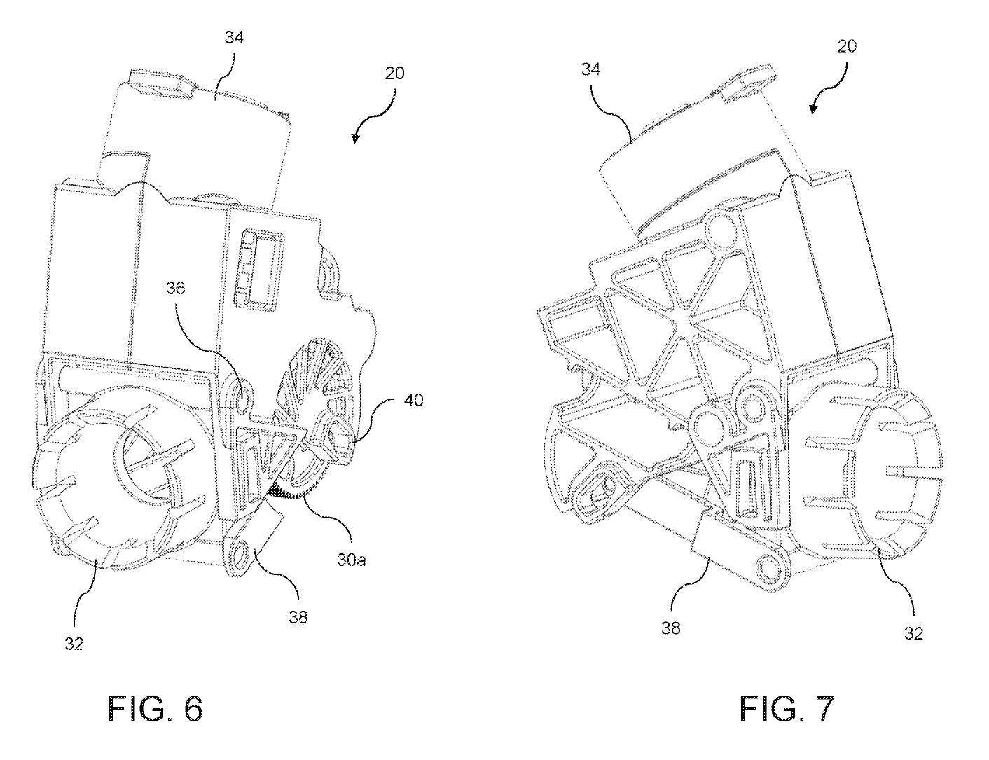

In the illustrated example, the first gear 30a includes a guide or track and a pin at the second end of the pivot link 38 rides within the track of the first gear 30a as the gear 30a rotates to cause movement of the pivot link 38 and socket element 32. That is, the track of the first gear 30a is an expanding or contracting spiral (e.g., an Archimedes spiral) that has a variable radius relative to the center point or axis of rotation of the first gear 30a and the pin at the second end of the pivot link 38 is rotationally constrained relative to the first gear 30a, such as by engaging a recess or tab 40 of the housing (FIGS. 4 and 6). As the first gear 30a rotates about its pivot axis and the second end of the pivot link 38 rides within the track of the first gear 30a, the distance between the second end of the pivot link 38 and the pivot axis changes due to the spiral shape of the track and imparts movement of the socket element 32 relative to the housing. Simply put, as the first gear 30a rotates, the pin at the second end of the pivot link 38 is rotationally constrained and moves radially within a channel of the tab 40. The channel may be angled so that this linear movement pushes the pivot link 38 outward away from the gear 30a or pulls the pivot link 38 in toward the gear 30a, and causes corresponding pivoting of the socket element 32. This tilts the mirror head 12 between positions.

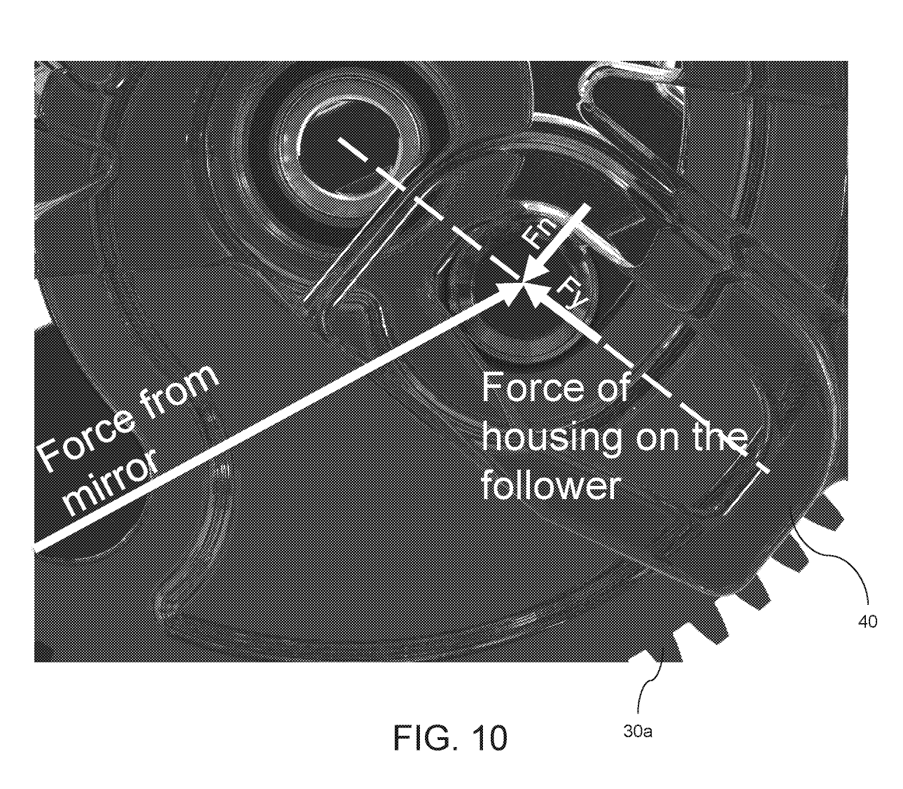

As shown in FIG. 10, the first gear 30a may be oriented such that little to no torque load is transferred from the mirror head 12, through the socket element 32 and pivot link 38 to the gear 30a. In other words, with the mirror head 12 attached to the socket element 32, the mirror head 12 is adjustable by the driver of the vehicle relative to the socket element 32 to set the rearward view provided by the mirror assembly. Geometry of the first gear 30a and pivot link 38 may prevent or preclude this torque from transferring to the gear train 30 and motor 28. For example, about 40 percent of the mirror load or less travels to the cam geometry. Because the load from the second end of the pivot link 38 has a torque arm of about one millimeter or less about the axis of the first gear 30a, the torque on the cam is reduced to almost zero.

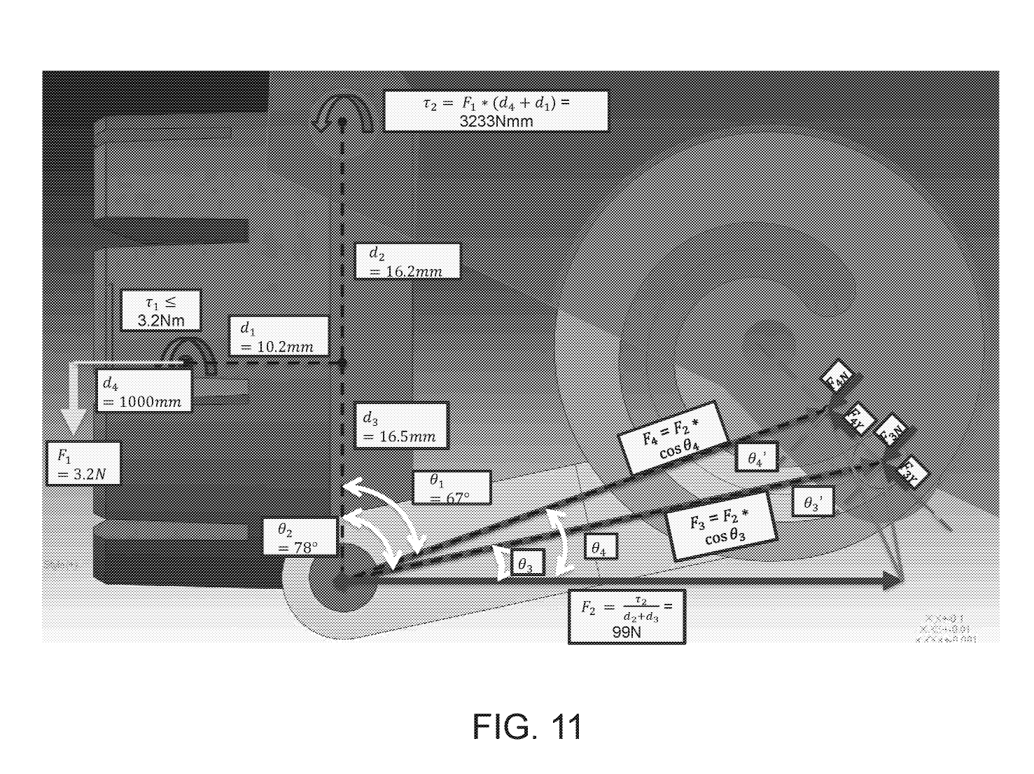

Further, the actuator geometry may provide adequate torque for adjusting the socket element 32 and mirror head 12 between positions. For example, and such as shown in FIG. 11, with a targeted actuator torque based on socket torque specifications of about 3.2 Nm, a gear train torque of about 0.5 Nm and a cam mechanical advantage of about 20 to 1, the actuator 20 may provide torque of about 10 Nm. Thus, the gear reduction may be adjusted to speed up the transition while still achieving targeted torque.

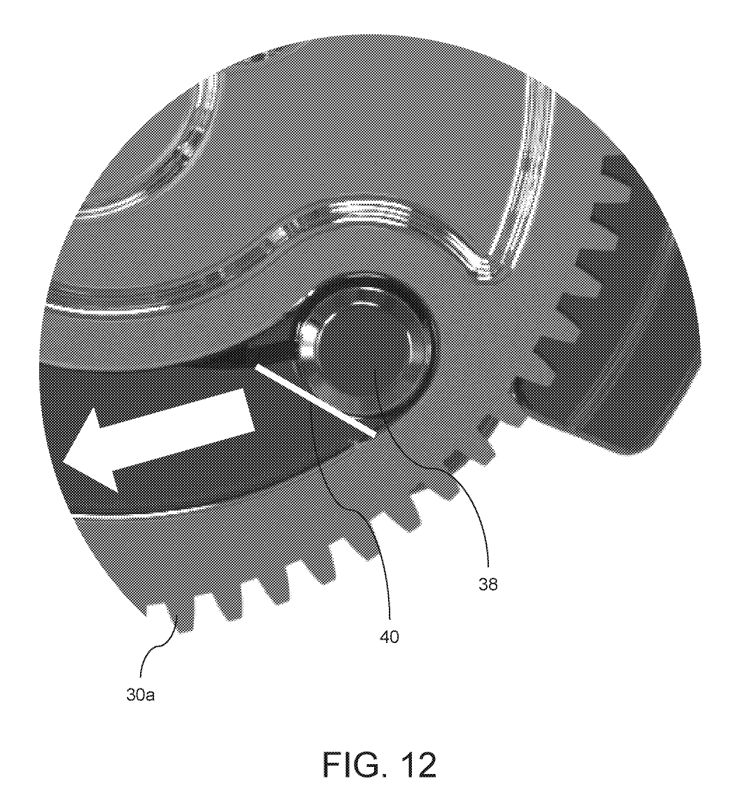

Moreover, the wedge-shaped housing track or tab 40 provides a stable follower guide when the end of travel is reached (FIG. 12). That is, when the pin at the second end of the pivot link 38 reaches the end of the track of the gear 30a, the pin may be wedged between the end of the track and the tab 40 of the housing, thus securing the mirror head in the daytime or nighttime position. This is useful in the end positions, where a negative mirror load may otherwise cause vibration due to tolerances in the cam loop. The wedge feature reduces the need for tight tolerancing on the cam geometry while adding a cinch feature that enhances vibration performance and may stop operation of the motor 28 at the end positions.

Optionally, the actuator 20 may allow for cable routing between the mirror head and a vehicle wiring harness. Cables may be routed through the socket element 32 and out through a housing channel.

Thus, the actuator may be built into the mirror stay or windshield mount. This provides a simple known connection between the mirror and windshield. Further, it removes the need for a flip tab or physical toggle at the mirror head, which is beneficial in high content mirrors, such as those with downward facing cameras (e.g., for a driver monitoring system). In other words, there is more space available within the mirror head, such as for electronic components (e.g., processing circuitry) and/or cameras or sensors.

Upon activation (through button on the mirror, light sensor feedback, input from the vehicle), the actuator tilts up or down from the current position (e.g., five degrees between positions). The mirror socket connection is still present so the mirror may be manually adjusted by the driver as normal. The actuator cinches in each state and prevents back drive so that manually moving the mirror head does not change the actuator state.

The packaging of the interior rearview mirror assembly may be kept small and compact as no toggle mechanism is needed at the mirror. In other words, pulling the toggle mechanism out of the mirror provides a thinner and more aesthetically pleasing design with less mirror head weight. The actuator functionality may fit into any mirror regardless of packaging constraints as the actuator is packaged entirely within a stay located behind the mirror head. Integration into other mirrors may be simple as the actuator does not require modification to fit a different mounting strategy.

Optionally, an interchangeable mirror mount may be swapped for different vehicle mounting strategy or mirror placement. The mounting feature may be sandwiched between the two actuator housing halves, twist locked or screwed in, or part of an overmold.

The mirror assembly may utilize characteristics of mirror assemblies described in U.S. Publication No. 2025-0214509, which is hereby incorporated herein by reference in its entirety.

The interior mirror assembly may comprise a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2024-0064274; US-2021-0162926; US-2021- 0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITYTM mirror).

The prismatic mirror assembly may utilize aspects of the mirror assemblies described in U.S. Pat. Nos. 6,318,870 and/or 7,249,860, and/or U.S. Publication No. US- 2010-0085653, which are hereby incorporated herein by reference in their entireties. Optionally, for example, the interior rearview mirror assembly may comprise a prismatic mirror assembly, such as the types described in U.S. Pat. Nos. 7,289,037; 7,249,860; 6,318,870; 6,598,980; 5,327,288; 4,948,242; 4,826,289; 4,436,371 and/or 4,435,042, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177 and/or 7,255,451, which are all hereby incorporated herein by reference in their entireties.

The mirror assembly may include a camera or sensor or light of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 12,403,834; 12,393,089; 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2025-0329174; US-2024-0383406; US-2024-0190456; US-2024-0168355; US-2022-0377219; US-2022- 0254132; US-2022-0242438; US-2021-0323473; US-2021-0291739; US-2020-0320320; US-2020-0202151; US-2020-0143560; US-2019-0210615; US-2018-0231976; US-2018- 0222414; US-2017-0274906; US-2017-0217367; US-2016-0209647; US-2016-0137126; US-2015-0352953; US-2015-0296135; US-2015-0294169; US-2015-0232030; US-2015- 0092042; US-2015-0022664; US-2015-0015710; US-2015-0009010 and/or US-2014- 0336876, and/or International Publication Nos. WO 2026/019985 and/or WO 2025/231198, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Changes and modifications in the specifically described embodiments may be carried out without departing from the principles of the present invention, which is intended to be limited only by the scope of the appended claims as interpreted according to the principles of patent law.

1. A vehicular interior rearview mirror assembly, the vehicular interior rearview mirror assembly comprising:a mirror head adjustable relative to a mounting base, wherein the mounting base is configured to mount the vehicular interior rearview mirror assembly at an interior portion of an interior cabin of a vehicle;wherein the mirror head accommodates a mirror reflective element;wherein, with the vehicular interior rearview mirror assembly mounted at the interior portion of the interior cabin of the vehicle, the mirror head is adjustable to set a rearward view for a driver of the vehicle;an electrically-operable actuator that, with the vehicular interior rearview mirror assembly mounted at the interior portion of the interior cabin of the vehicle, is operable to tilt the mirror head between at least (i) a first position relative to the mounting base and (ii) a second position relative to the mounting base different from the first position;wherein the electrically-operable actuator comprises (i) a socket element that receives a ball member, (ii) a cam gear having an arcuate track, (iii) an electrically- operable motor that drives the cam gear and (iv) a pivot link attached at the socket element, and wherein the pivot link comprises a pin; andwherein, when the electrically-operable actuator is operated, the pin of the pivot link rides along the arcuate track of the cam gear to tilt the mirror head between the first position and the second position.

2. The vehicular interior rearview mirror assembly of claim 1, wherein the pin of the pivot link is rotationally constrained relative to the cam gear.

3. The vehicular interior rearview mirror assembly of claim 2, wherein, when the electrically-operable actuator is operated, and as the pin rides along the arcuate track, the pin moves radially relative to an axis of rotation of the cam gear.

4. The vehicular interior rearview mirror assembly of claim 1, wherein the arcuate track comprises an Archimedes spiral.

5. The vehicular interior rearview mirror assembly of claim 1, wherein the electrically- operable actuator comprises a housing, and wherein the mounting base is attached to the housing of the electrically-operable actuator.

6. The vehicular interior rearview mirror assembly of claim 1, wherein the mirror reflective element comprises a prismatic mirror reflective element, and wherein the first position comprises a day position, and wherein the second position comprises an anti- glare night position.

7. The vehicular interior rearview mirror assembly of claim 1, wherein the mirror head accommodates a video display screen that, with the vehicular interior rearview mirror assembly mounted at the interior portion of the interior cabin of the vehicle, is operable to display video images that are viewable through the mirror reflective element, and wherein the first position comprises a mirror mode position where (i) reflections at the mirror reflective element provide the rearward view for viewing by the driver and (ii) the video display screen is not electrically operated to display video images, and wherein the second position comprises a video display mode position where the video display screen is electrically operated to display video images representative of images captured by an exterior rearward viewing camera of the vehicle.

8. The vehicular interior rearview mirror assembly of claim 1, wherein the mirror head tilts between 3 degrees and 6 degrees from the first position to the second position.

9. The vehicular interior rearview mirror assembly of claim 1, wherein the electrically- operable actuator operates to tilt the mirror head between the first position and the second position responsive to at least one selected from the group consisting of (i) a user input operable by the driver of the vehicle and (ii) detection of glare light incident at the mirror reflective element.

10. The vehicular interior rearview mirror assembly of claim 1, wherein the ball member is attached to the mirror head.

11. The vehicular interior rearview mirror assembly of claim 1, wherein the pivot link comprises a first end region and a second end region distal from the first end region, and wherein the first end region is pivotally attached at the socket element, and wherein the pin is disposed at the second end region.

12. The vehicular interior rearview mirror assembly of claim 11, when the electrically- operable actuator is operated, (i) the electrically-operable motor drives the cam gear so the pin of the pivot link rides along the arcuate track of the cam gear to impart movement of the first end region of the pivot link and (ii) the socket element pivots relative to the mounting base to tilt the mirror head between the first position and the second position.

13. The vehicular interior rearview mirror assembly of claim 1, wherein, with the vehicular interior rearview mirror assembly mounted at the interior portion of the interior cabin of the vehicle, the electrically-operable actuator is fixed relative to the mounting base.

14. A vehicular interior rearview mirror assembly, the vehicular interior rearview mirror assembly comprising:a mirror head adjustable relative to a mounting base, wherein the mounting base is configured to mount the vehicular interior rearview mirror assembly at an interior portion of an interior cabin of a vehicle;wherein the mirror head accommodates a prismatic mirror reflective element;wherein, with the vehicular interior rearview mirror assembly mounted at the interior portion of the interior cabin of the vehicle, the mirror head is adjustable to set a rearward view for a driver of the vehicle;an electrically-operable actuator that, with the vehicular interior rearview mirror assembly mounted at the interior portion of the interior cabin of the vehicle, is operable to tilt the mirror head between at least (i) a day position relative to the mounting base and (ii) an anti-glare night position relative to the mounting base different from the day position;wherein, with the mirror head tilted to the day position, reflections at a rear surface of the prismatic mirror reflective element provide the rearward view for the driver of the
vehicle, and wherein, with the mirror head tilted to the anti-glare night position, reflections at a front surface of the prismatic mirror reflective element provide the rearward view for the driver of the vehicle;wherein, with the vehicular interior rearview mirror assembly mounted at the interior portion of the interior cabin of the vehicle, the electrically-operable actuator is fixed relative to the mounting base;wherein the electrically-operable actuator comprises (i) a socket element that receives a ball member, (ii) a cam gear having an arcuate track, (iii) an electrically- operable motor that drives the cam gear and (iv) a pivot link attached at the socket element;wherein the pivot link comprises a first end region and a second end region distal from the first end region, and wherein the first end region is pivotally attached at the socket element, and wherein the pivot link comprises a pin disposed at the second end region;
and wherein, when the electrically-operable actuator is operated, the pin of the pivot link rides along the arcuate track of the cam gear to tilt the mirror head between the day position and the anti-glare night position.

15. The vehicular interior rearview mirror assembly of claim 14, wherein the pin of the pivot link is rotationally constrained relative to the cam gear, and wherein, when the electrically-operable actuator is operated, and as the pin rides along the arcuate track, the pin moves radially relative to an axis of rotation of the cam gear.

16. The vehicular interior rearview mirror assembly of claim 14, wherein the mirror head tilts between 3 degrees and 6 degrees from the day position to the anti-glare night position.

17. The vehicular interior rearview mirror assembly of claim 14, wherein the electrically- operable actuator operates to adjust the mirror head between the day position and the anti-glare night position responsive to at least one selected from the group consisting of (i) a user input operable by the driver of the vehicle and (ii) detection of glare light incident at the prismatic mirror reflective element.

18. A vehicular interior rearview mirror assembly, the vehicular interior rearview mirror assembly comprising:a mirror head adjustable relative to a mounting base, wherein the mounting base is configured to mount the vehicular interior rearview mirror assembly at an interior portion of an interior cabin of a vehicle;wherein the mirror head accommodates a mirror reflective element;wherein, with the vehicular interior rearview mirror assembly mounted at the interior portion of the interior cabin of the vehicle, the mirror head is adjustable to set a rearward view for a driver of the vehicle;wherein the mirror head accommodates a video display screen that, with the vehicular interior rearview mirror assembly mounted at the interior portion of the interior cabin of the vehicle, is operable to display video images that are viewable through the mirror reflective element;an electrically-operable actuator that, with the vehicular interior rearview mirror assembly mounted at the interior portion of the interior cabin of the vehicle, is operable to tilt the mirror head between at least (i) a mirror mode position relative to the mounting base and (ii) a video display mode position relative to the mounting base different from the mirror mode position;wherein, with the mirror head tilted to the mirror mode position, (i) reflections at the mirror reflective element provide the rearward view for viewing by the driver and (ii) the video display screen is not electrically operated to display video images;wherein, with the mirror head tilted to the video display mode position, the video display screen is electrically operated to display video images representative of images captured by an exterior rearward viewing camera of the vehicle;wherein, with the vehicular interior rearview mirror assembly mounted at the interior portion of the interior cabin of the vehicle, the electrically-operable actuator is fixed relative to the mounting base;wherein the electrically-operable actuator comprises (i) a socket element that receives a ball member, (ii) a cam gear having an arcuate track, (iii) an electrically- operable motor that drives the cam gear and (iv) a pivot link attached at the socket element; and
wherein the pivot link comprises a first end region and a second end region distal from the first end region, and wherein the first end region is pivotally attached at the socket element, and wherein the pivot link comprises a pin disposed at the second end region;
and wherein, when the electrically-operable actuator is operated, the pin of the pivot link rides along the arcuate track of the cam gear to tilt the mirror head between the mirror mode position and the video display mode position.

19. The vehicular interior rearview mirror assembly of claim 18, wherein the pin of the pivot link is rotationally constrained relative to the cam gear, and wherein, when the electrically-operable actuator is operated, and as the pin rides along the arcuate track, the pin moves radially relative to an axis of rotation of the cam gear.

20. The vehicular interior rearview mirror assembly of claim 19, wherein the mirror head tilts between 3 degrees and 6 degrees from the mirror mode position to the video display mode position.
